(19) United States
(12) Patent Application Publication
(10) Pub. No.: US 2022/0250552 A1
(43) Pub. Date: Aug. 11, 2022

(54) SURFBOARD CARRIER

(71) Applicants: Aviad Avraham DAYANI, Ashkelon (IL); Ofir Dvir AMIDI, Ashkelon (IL)

(72) Inventor: Aviad Avraham DAYANI, Ashkelon (IL)

(73) Assignees: Aviad Avraham DAYANI, Ashkelon (IL); Ofir Dvir AMIDI, Ashkelon (IL)

(21) Appl. No.: 17/608,167

(22) PCT Filed: Apr. 17, 2020
(86) PCT No.: PCT/IL2020/050455

§ 371 Date: Nov. 2, 2021

Related U.S. Application Data
(60) Provisional application No. 62/843,590, filed on May 6, 2019.

(51) Int. Cl. B60R 9/08; B60R 9/02

(52) U.S. Cl. CPC B60R 9/08; B60R 9/02

(57) ABSTRACT

The current disclosure relates to a carrier holding an object alongside a car. In some embodiments, the carrier includes a bracket configured for supporting an object alongside a vehicle. Optionally, the bracket is connected to a mount configured to support the bracket on a car door. For example, the mount may include a brace for supporting the weight of the bracket on a top surface of the door and/or a stabilizer, for example for steadying the bracket. In some embodiments, the stabilizer may rest on and/or attach to an outer surface of the car. Optionally a set of two brackets are used to hold a long object (for example a surfboard) alongside a car. For example, two u-shaped brackets may hold a surfboard. Optionally one bracket is mounted on a front door and another bracket is mounted on a rear door.

### RELATED APPLICATION

This application claims the benefit of priority under 35 USC § 119(e) of U.S. Provisional Patent Application No. 62/843,590 filed 6 May 2019, the contents of which are incorporated herein by reference in their entirety.

### FIELD AND BACKGROUND OF THE INVENTION

The present invention, in some embodiments thereof, relates to side mounted car carrier and, more particularly, but not exclusively, a carrier for holding a surfboard on the side of a car.

### SUMMARY OF THE INVENTION

According to an aspect of some embodiments of the invention, there is provided a carrier for support an object alongside a car including: a plurality of brackets, each bracket including each of the plurality of brackets including a respective brace for support the bracket on the car; an open topped profile configured to support the object from at least two sides.

According to some embodiments of the invention, each respective brace is configured for supporting the bracket on a door of the car.

According to some embodiments of the invention, each respective brace includes a support configured to be held between a closed door and a roof of the car.

4a. The carrier of claim 1, wherein a weight of each bracket of the plurality of bracket of the plurality of brackets is less than 5 kg.

According to some embodiments of the invention, a length of the support is adjustable.

According to some embodiments of the invention, the support includes a movable stopper which is moved along a length of the support thereby adjusting the length of the support.

According to some embodiments of the invention, a long dimension of each bracket of the plurality of brackets is less than 3/2 meters.

According to some embodiments of the invention, the carrier further includes: a stabilizer configured to attach to a surface of a car.

According to some embodiments of the invention, the carrier is configured to hold a surfboard on a moving car within the profile defined between the side mirrors of the car.

8a. The carrier of claim 7, wherein the carrier is configured to carry a portion of the surfboard above a roof line of the car.

According to some embodiments of the invention, the carrier is configured to carry a portion of the surfboard below a roof line of the car.

According to some embodiments of the invention, each bracket includes at least two upward directed prongs with a gap between the prongs for holding the object.

According to some embodiments of the invention, each of the plurality of brackets is configured such that when the carrier is supported on a car, the gap between the prongs is directed along a width of the car.

According to an aspect of some embodiments of the invention, there is provided a method of carrying an object including: reversibly mounting a plurality of brackets on a one side of a car each bracket having a gap opening on an upper portion thereof; passing the object downward through the opening into the gap of each of the plurality of brackets; supporting part of a weight of the object on each of the plurality of the brackets with a length of the object along the length of the car.

According to some embodiments of the invention, for each of the brackets, the mounting includes supporting a weight of the bracket on a door of the car.

According to some embodiments of the invention, each bracket includes a support and wherein the supporting includes positioning the support above a frame of the door and closing the support between the door and a frame of the car.

According to some embodiments of the invention, the method further includes adjusting the length of the support to fit tightly to the door.

According to some embodiments of the invention, the adjusting includes attaching a movable stopper to the support.

According to some embodiments of the invention, the attaching is to a window of the car.

According to some embodiments of the invention, the method further includes: attaching a fastener to a bottom of the door and applying a contra downward force on the support from the fastener.

According to some embodiments of the invention, each of the plurality of brackets includes a stabilizer and the mounting further includes stabilizing the bracket by connecting a stabilizer to the car.

According to some embodiments of the invention, the stabilizing includes attaching the stabilizer to a surface of the car.

According to some embodiments of the invention, the supporting includes supporting a portion of the object under a roof line of the car and a portion of the object above the roof line of the car.

According to some embodiments of the invention, the supporting includes supporting the object above a side mirror of the car such that a driver has a line of sight to the side mirror under the object.

According to some embodiments of the invention, a lower portion of each bracket is configured to support the object and wherein the supporting is on the lower portion.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flow chart illustration of a method of mounting a bracket to a car in accordance with some embodiments of the current invention;

FIG. 2 is a flow chart illustration of a method of mounting a bracket to a car in accordance with some embodiments of the current invention;

FIG. 3 is a flow chart illustration of a method of holding an object on a car in accordance with some embodiments of the current invention;

FIG. 4 is a flow chart illustration of a method of holding a surfboard and the like on a car in accordance with some embodiments of the current invention;

FIG. 5 is a flow chart illustration of a method of holding a surfboard and the like on a car in accordance with some embodiments of the current invention;

FIG. 6 is a block diagram illustrating a carrier for a car in accordance with some embodiments of the current invention;

FIG. 7 is a block diagram illustrating a carrier for a car in accordance with some embodiments of the current invention;

FIG. 8 is a block diagram illustrating a multibracket carrier for a car in accordance with some embodiments of the current invention;

FIG. 9 is a sideview image of a surfboard held on a car using a carrier in accordance with some embodiments of the current invention;

FIG. 10 is an image of a carrier mounted on a car in accordance with some embodiments of the current invention;

FIG. 11 is an image of a carrier mounted on a car in accordance with some embodiments of the current invention;

FIG. 12 is a frontal view image of a surfboard held on a car using a carrier in accordance with some embodiments of the current invention;

FIG. 13 is an image of supporting a mount on a car door in accordance with some embodiments of the current invention;

FIG. 14 is a perspective view of a bracket in accordance with some embodiments of the current invention;

FIG. 15 is an image of a bracket in accordance with some embodiments of the current invention;

FIG. 16 is an image of a brackets positioned for holding a surfboard in accordance with some embodiments of the current invention;

FIG. 17 is a flowchart illustration of a method of attaching a rack to a vehicle in accordance with an embodiment of the current invention;

FIG. 18 is a block diagram of a bracket in accordance with an embodiment of the current invention;

FIG. 19A is a perspective view from the inner side of the door of attaching an adjustable brace attaching a bracket into a door in accordance with an embodiment of the current invention;

FIG. 19B is a perspective view from an inner side of the door of attaching an adjustable brace attaching a bracket into a door with a bent tongue in accordance with an embodiment of the current invention;

FIG. 19C is a perspective view from an outer side of the door of attaching an adjustable brace attaching a bracket into a door with an external shield in accordance with an embodiment of the current invention;

FIG. 20 is an external perspective view of attaching a bracket to a car in accordance with an embodiment of the current invention; and

FIG. 21 illustrates a set of brackets attached to a car for carrying an object in accordance with an embodiment of the current invention.

### DESCRIPTION OF SPECIFIC EMBODIMENTS OF THE INVENTION

The present invention, in some embodiments thereof, relates to side mounted car carrier and, more particularly, but not exclusively, a carrier for holding a surfboard on the side of a car.

### Overview

An aspect of some embodiments of the current invention relates to a carrier holding an object alongside a car. In some embodiments, the carrier includes a bracket configured for supporting an object alongside a vehicle. Optionally, the bracket is connected to a brace configured to support the bracket on a car door. For example, the brace may include a hook and/or a tongue and nub for supporting the weight of the bracket on a top surface of the door. Optionally, a stabilizer steadies the bracket. In some embodiments, the stabilizer may rest on and/or attach to a window and/or a fender and/or a door surface. Optionally, the bracket is sized and shaped to fit into the profile of the car (e.g., between a side edge of a roof and the outer edge of a rearview mirror). For example, the width of the bracket projected out from the edge of the roof of the car. For example, the width of the bracket may be less than 20 cm and/or less than 15 cm.

An aspect of some embodiments of the current invention relates to a set of brackets configured to hold a long object (for example a surfboard) alongside a car. Optionally, each bracket retains an object between two side (e.g., with upward pointed prongs or walls) and/or a bottom supporting the object from below. Optionally, the brackets may be open on the top. For example, one bracket is mounted on a front door and another bracket is mounted on a rear door. Alternatively or additionally, two brackets may be mounted on a single door and/or one bracket may be mounted on a side door while the other is mounted on a front fender, a rear fender, a rear hatch door, a rear window and/or a front windshield. In some embodiments, a retainer (for example a strap) retains the object within the bracket. For example, the brackets may be configured to hold a surfboard. Optionally each bracket is small and/or light enough to be carried by a pedestrian and/or to easily fit in the trunk of a car. For example, the long dimension of each bracket may be less than 0.5 meters and/or less than 0.75 meters and/or less than 1 meter and/or less than 1.5 meters. For example, the longer width of the bracket (perpendicular to the length thereof) may be less than 1 meter and/or less than 0.5 meter and/or less than 0.25 meter and/or less than 0.15 meter. For example, the shorter width of the bracket (perpendicular to the length thereof and/or perpendicular to the longer width thereof) may be less than 0.75 meter and/or less than 0.5 meter and/or less than 0.25 meter and/or less than 0.15 meter and/or less than 0.1 meter and/or less than 0.5 meter. Optionally, two brackets are included in a kit. Additionally or alternatively, the kit may include a restraint (e.g. a strap) for holding the object within the bracket and/or a carrying back for a pedestrian to carry two brackets. Optionally, the two brackets may be used to carry an object having long dimension of greater 1 meter and/or greater than 1.5 meters and/or greater than 2 meters and/or greater than 3 meters. For example, the longer width of the object (perpendicular to the length thereof) may be greater than 1 meter and/or greater than 0.5 meter and/or greater than 0.25 meter. Each bracket may weight less than 10 kg and/or less than 5 kg and/or less than 3 kg and/or less than 2 kg and/or less than 1 kg. In some embodiments, when each bracket is supported on a car, a gap between the prongs is open at least 1 cm perpendicular to the length of the car and/or at least 3 cm and/or at least 9 cm. For example, when the brackets are connected to the car, the gaps may line up along side the car and/or the bottoms of the brackets may line up at a similar height (within 1 cm and/or within 5 cm and/or withing 10 cm) for example to carry a long object resting inside each of the gaps substantially parallel to the long axis if the car.

An aspect of some embodiments of the current invention relates to a method of transporting an object. In some embodiments, two or more brackets are reversibly mounted to a car. For example, at least one of the brackets may be supported by a support that his held between a door and a door frame of the passenger compartment of the car. Additionally or alternatively, the bracket may be stabilized by a stabilizer that is attached to a surface of the car, for example using suction cups and/or magnets. In some embodiments, a long object will be supported between two brackets. Optionally, the object will have long dimension along the length of the car (e.g., within 10 degrees and/or within 20 degrees of parallel to the long axis of the car) and/or a width directed vertically (e.g. within 10 degrees and/or within 20 degrees of and/or within 45 degrees of vertical) and/or a short dimension directed along the width of the car (e.g. within 10 degrees and/or within 20 degrees and/or within 45 degrees of a horizontal direction perpendicular to the long axis of the car). For example, a pair of brackets may be supported on the car and/or the object two be carried may be slid downward into an opening in each of the brackets.

### EXEMPLARY EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

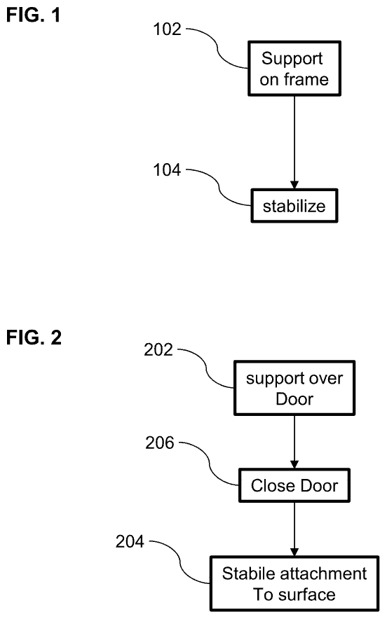

FIG. 1 is a flow chart illustration of a method of mounting a bracket to a car in accordance with some embodiments of the current invention. Optionally, a bracket is mounted to a car in a strong and stable manner to hold an object (for example a surfboard and/or a ski) hanging over the side of the car even during high speed travel and/or sudden maneuvers such a braking and/or turning. In some embodiments, the bracket is supported 102 on a frame of a car. For example, the bracket may be supported 102 on a frame of a door (e.g., the window frame of the door panel). Alternatively or additionally, a bracket bay be supported 102 on other parts of a car, for example, frame of a rear hatch and/or a frame of a windshield and/or a frame of a roof. For example, the bracket may be supported between a frame of the door and a frame of the passenger compartment (e.g., the roof). Optionally the rack is stabilized 104 by attaching to another point on the car. For example, a stabilizer may be attached to window, roof and/or a fender of a car for example using one or more magnets and/or suction cups. Optionally a support and/or a stabilizer may be grasped between a closed door and a frame of the car and/or between a window and a door frame and/or the stabilizer may be connected to a molding and/or channel and/or a roof and/or a roll bar and/or roof rack etc. Optionally a strap may hold or steady a bracket.

FIG. 2 is a flow chart illustration of a method of mounting a bracket to a car in accordance with some embodiments of the current invention. In some embodiments, a support of a holding bracket includes support that supports 202 the weight of the bracket on the top of a car side door. Optionally, the door of the car is closed 206 with the support immobilized between the door and the body of the car. In some embodiments, a bracket is stabilized by attaching 204 it to more than one point on the car and/or the door. For example, a stabilizer may be attached 204 to an outer surface of the car, for example a window and/or a fender. Alternatively or additionally, a stabilizer may include a hook attached to the top of the door and/or a channel and/or protrusion on the exterior of the car. Alternatively or additionally, a stabilizer may be immobilized by sandwiching it between a door and a body of the car and/or between a window and a frame of a door and/or the body of the car. In some embodiments a strap may be included in the support and/or stabilizer of the bracket.

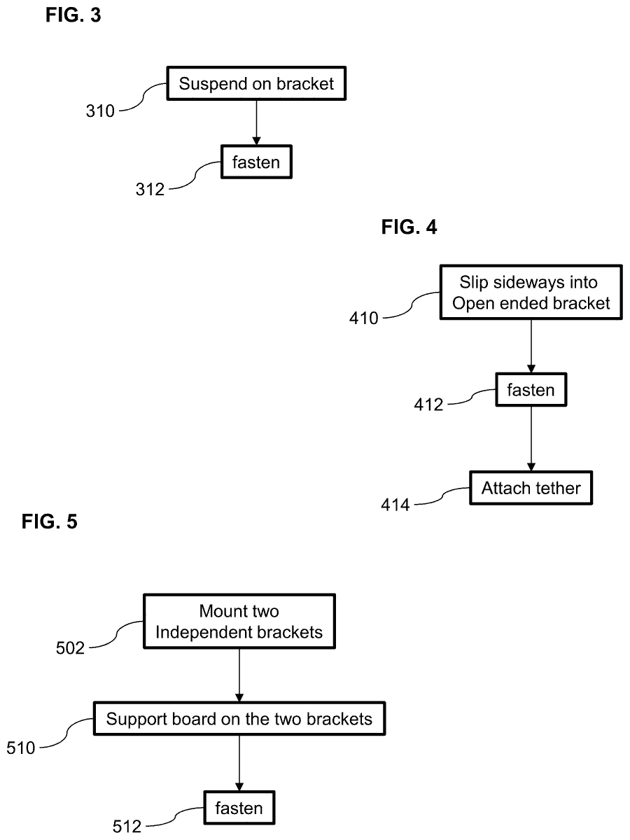

FIG. 3 is a flow chart illustration of a method of holding an object on a vehicle in accordance with some embodiments of the current invention. In some embodiments, a bracket including an open-ended channel is mounted onto the side of a vehicle. Optionally, a portion of an object to be carried is slid into the channel and/or suspended 310 alongside the vehicle. For example, the channel may have an open top and a closed bottom and/or the object may slide downward into the channel. Optionally, the object is fastened 312 to the bracket and/or the vehicle, for example with a strap.

FIG. 4 is a flow chart illustration of a method of holding a surfboard and the like on a car in accordance with some embodiments of the current invention. In some embodiments, a bracket may have an open ended bracket, for example, the bracket may be u-shaped. For example, the bracket may be suspended on the side of a car with the opening of its channel facing upward. Optionally, the opening is on a top of gap Alternatively or additionally, the opening may be near the top of the gap, on an upper portion of the bracket. An object to be carried may be inserted into the channel and/or fully and/or partially supported by the bracket. For example, a long thin board and/or plank may slide 410 into the channel and/or be supported by the base of the channel. For example, the plank may be a part of a surfboard and/or a ladder and/or a ski etc. Optionally, the object may be fastened 412 to the bracket and/or the car. For example, a strap and/or an elastic band (e.g., a bungee cord) and/or a clamp may hold the object steady and/or prevent it for slipping inside the bracket. Additionally or alternatively, a fastener of the object may be used to fasten the object to the car and/or to the bracket. For example, a tether of a surf board may be attached 414 to the bracket and/or the car. Optionally the bracket may be covered by a soft and/or a non-slip surface. For example, the covering may help to hold the object steady and/or prevent scratching the object. Optionally, the object and/or the bracket is held within the profile of the vehicle. For example, the object and/or the bracket may project away from the roof and/or the side of the car less than a side view mirror of the car.

FIG. 5 is a flow chart illustration of a method of holding a surfboard and the like on a car in accordance with some embodiments of the current invention. In some embodiments, two independent brackets will be mounted 502 alongside a vehicle and/or a long object will be supported 510 by the two brackets. Optionally, mounting 502 of the bracket on the car is reversible. Optionally, two small brackets may be used to support 510 a long object and/or the brackets may be small enough to fit easily into the vehicle when not in use. Optionally, each bracket will be independently mounted 502 and/or stabilized on the vehicle. For example, the two brackets may both be mounted 502 on a door and/or each bracket may be mounted 502 on a separate door (for example one bracket may be mounted 502 on a front door of a car while the other bracket is mounted 502 on the rear passenger door on the same side of the car. Alternatively or additionally, one bracket may be mounted 502 on a side door while the other is mounted 502 on a rear hatch and/or a bumper and/or a roof rack.

In some embodiments, two small light brackets may be carried by a pedestrian and reversibly mounted 502 on a vehicle. For example, the brackets may be placed on a rented vehicle and/or on a public transport vehicle (for example a taxi cab). In some embodiments this may facilitate transport of a long object (for example a board and/or a surfboard and/or a ladder and/or ski and/or a snow board etc.) without requiring a private car. For example, each bracket may weigh less than 2 kg and/or between 2 to 4 kg and/or between 4 to 8 kg and/or between 8 to 15 kg. For example, a long dimension of each bracket may be less than 40 cm and/or between 40 to 80 cm and/or between 80 cm to 150 cm and/or between 150 to 250 cm. For example, the shorter dimensions of each bracket may be less than 20 cm and/or range between 20 to 40 cm and/or between 40 to 80 cm and/or between 80 to 150 cm. The transported object may be fastened 512 to the bracket, for example by a strap and/or a loop and/or a latch and/or magnet and/or a clamp.

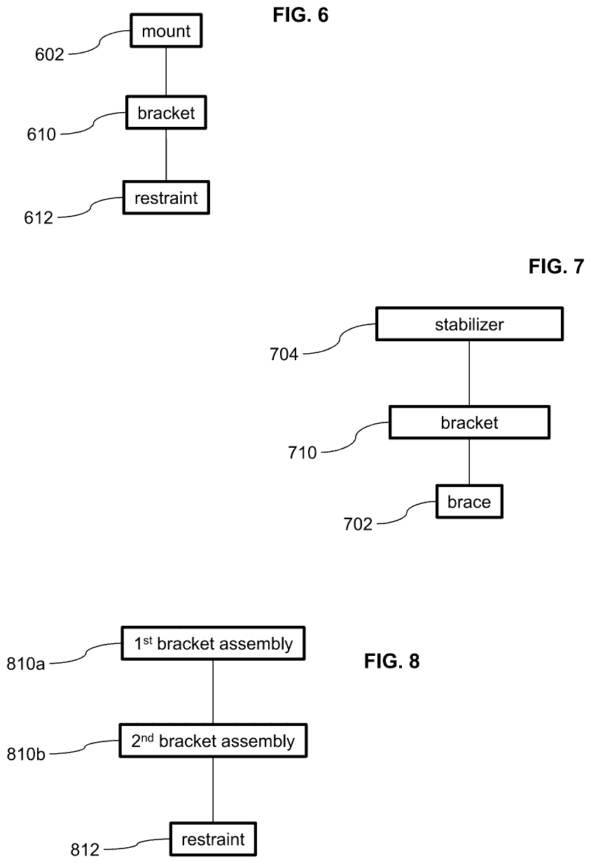

FIG. 6 is a block diagram illustrating a carrier for a car in accordance with some embodiments of the current invention. Optionally a carrier may include a mount 502 for supporting the carrier on a vehicle and/or a bracket 610 for holding an object and/or a restraint 612 for immobilizing the object (for example by fastening the object to the bracket 610 and/or the car). For example, a mount 602 may include a support for supporting the bracket on a car and/or a stabilizer (e.g., a strap and/or a stabilizer) for stabilizing the object with respect to the car.

FIG. 7 is a block diagram illustrating a carrier for a car in accordance with some embodiments of the current invention. In some embodiments, a bracket 710 is supported on a car with a support 702. For example, the support 702 may hook over a door of the car and/or be sandwiched between the door and the body of the car. Optionally the bracket 710 may be u-shaped for example to hold an object in a channel of the “u” and/or to support the object on a base at the bottom or the “u”. Optionally the bracket 710 may be stabilized by a stabilizer 704. For example, the stabilizer 704 may include a stabilizing framework and/or a suction cup and/or a magnet that holds it to a fender of the car and/or a window. Alternatively or additionally, a stabilizer 704 may include a strap and/or a cord that hooks to channel of the car and/or an opening and/or a roof and/or a bottom and/or a bumper etc.

FIG. 8 is a block diagram illustrating a multibracket carrier for a car in accordance with some embodiments of the current invention. In some embodiments a carrier may include two bracket assemblies 810a, 810b (for example a bracket assembly 810a, 810b may include a bracket and/or a fastener and/or a mount and/or the mount may include a support and/or a stabilizer for example as described in various embodiments herein). Optionally, each bracket assembly 810a, 810b may be independent and/or attached and/or detached and/or transported independently. Alternatively or additionally, the bracket assemblies 810a, 810b may be interconnected and/or may be integrated into a single carrier unit that is attached, detached and/or moved as a unit. Optionally a restraint 812 is supplied to hold an object (e.g., a surfboard, a ladder etc.) to the bracket assemblies 810a, 810b.

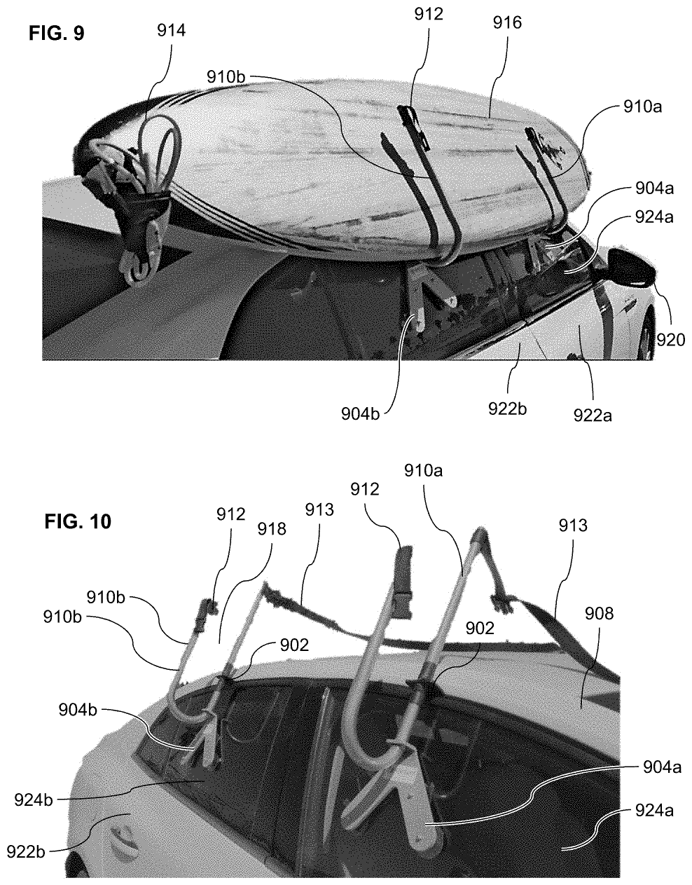

FIG. 9 is a sideview image of a surfboard 916 held on a car using a carrier in accordance with some embodiments of the current invention. For example, the surfboard 916 may be suspended on two brackets 910a, 910b projecting from a side door 922a, 922b and/or a roof of the car. Optionally, the surfboard 916 is held sideways and along the side of the car. For example, a long dimension of the board 916 may be directed along the long axis of the car (e.g., parallel to the long axis and/or at an angle of less than 5 degrees to the longitudinal axis and/or within 10 degrees of the longitudinal axis. For example, a width of the board 916 may be directed substantially vertically (e.g., at an angle of less than 5 degrees to the vertical and/or within 10 degrees of the vertical and/or within 30 degrees of the vertical and/or within 60 degrees of the vertical). In some embodiments, a first bracket 910a is suspended on a front side door 922a (for example the right-side passenger door 922a) of a car. In some embodiments, a second bracket 910b is suspended on a rear side door 922b (for example the right-side passenger door 922b) of a car. Optionally both brackets 910a, 910b are positioned on the same side of the car. For example, the object (e.g., the surfboard 916) is supported by the two brackets 910a, 910b (e.g., partially or fully between the two brackets 910a, 910b and/or partially or fully projecting ahead and/or behind the brackets 910a, 910b). In some embodiments, the object is attached to the brackets 910a, 910b by a restraint 912. For example, a surfboard 916 may be tightened against the bracket 910a, 910b using a strap. Optionally the bracket 910a, 910b and/or the strap may include a soft and/or non-slip surface (for example rubber, plastic or foam padding). Optionally, the object is suspended with a part of the field of vision of the driver unobstructed below the object, allowing the driver to see his side window 924a and/or allowing the driver to view his side view mirror 920. For example, the object may be suspended above the height of the mirror 920 and/or the object may be suspended above a portion of the window 924a (for example at least 2 cm and/or between 2 to 5 cm and/or between 5 to 10 cm and/or between 10 to 20 cm and/or between 20 to 40 cm and/or more of the window 924a below the object may unobstructed by the object. Optionally, the bracket 910a, 910b includes a stabilizer 904a, 904b. For example, stabilizer 904a, 904b may be connected to a window of a door 922a, 922b. Optionally, a tether 914 of the surfboard may also be connected to a bracket 910a, 910b.

FIG. 10 is an image of a carrier mounted on a car in accordance with some embodiments of the current invention. For example, the carrier may include one or more u-shaped brackets 910a, 910b mounted to the side of the car. For example, each bracket 910a, 910b may be suspended on a support 902 that is hooked over a top of door 922a, 922b and/or sandwiched between the door 922a, 922b and the body of the car. Optionally, a stabilizer 904a, 904b is attached to a surface of the car (for example a window 924a, 924b of the door) and/or holds the bracket 910a, 910b steady. For example, the stabilizer 904a, 904b may attach the bracket 910a, 910b to one or more points on the surface of the car. For example, the stabilizer 904a, 904b may be attached to two points of the surface of the car. For example, one or more suction cups may attach the stabilizer 904a, 904b to the window 924a, 924b of the door over which the support 902a, 902b is suspended. Optionally one, some or all of the bracket 910a, 910b and/or the stabilizer 904a, 904b and/or the support 902a, 902b may made of Aluminum and/or steel and/or fiberglass and/or plastic and/or another material. For example, the bracket 910a, 910b may be made of Aluminum and the support 902a, 902b may include a hook made of steel. For example, the bracket 910a, 910b and the hook may be made of Aluminum. For example, the bracket 910a, 910b may include a hollow aluminum bar bent into a u-shape and/or covered (in all or partially) with a non-stick and/or non scratch coating. Optionally, a restrainer of the surfboard may include a strap 913 and/or a buckle 912.

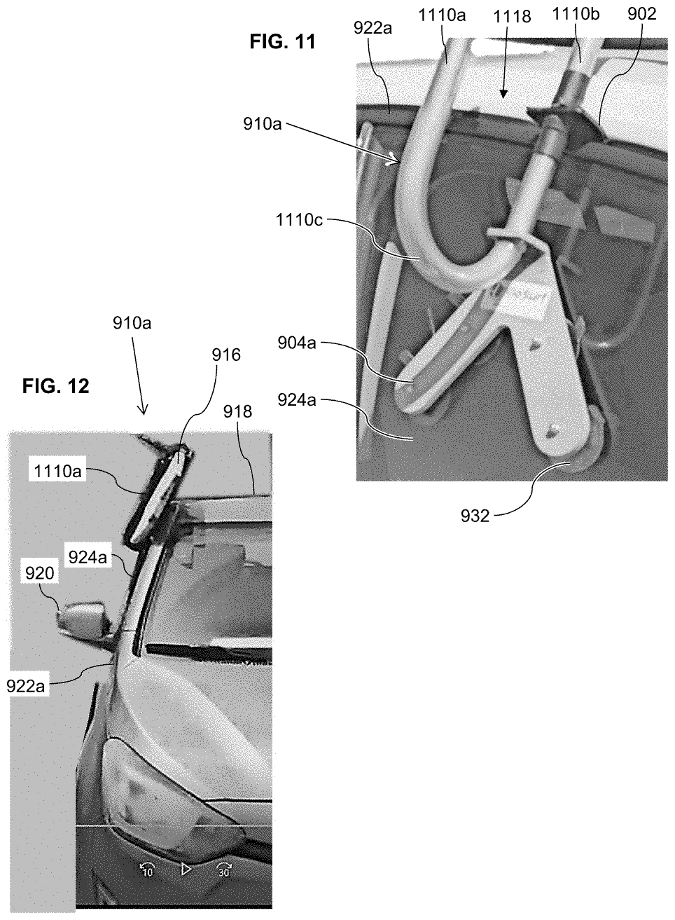

FIG. 11 is a close up image of attachment of a carrier on a car in accordance with some embodiments of the current invention. In some embodiments, two independent u-shaped brackets 910a, 910b are mounted on two doors 922a, 922b on one side of a car (for example the passenger side [right side in US, left side in England]). Alternatively or additionally, brackets 910a, 910b may be mounted on the driver side and/or brackets 910a, 910b may be mounted on both sides of the car. For example, a support 902 suspends the bracket on the top of a door 922a. Optionally, the car door 922a is closed sandwiching the support 902 between the top of the door 922a and the body of the car. Optionally, the bracket 910a may include an upward directed inner prong 1110b and/or outer prong 1110a and/or a base 1110c defining a gap 1118 into which a surfboard may be slid. In some embodiments, a stabilizer 904a attaches the bracket 910a to a window 924a of the door (for example the stabilizer 904a may be connected to the window 924a with one or more fasteners 932, for example suction cups). The bottom of the bracket 910a is optionally positioned to allow the driver to see below the bracket 910a out the passenger side window 924a and/or the passenger side rear view mirror 920. For example, the base 1110c of the bracket 910a on the front door 922a may be positioned above the center of the window 924. For example, the support 902 may be positioned along the inner prong 1110b of the bracket 910a between 10 to 15 cm and/or between 15 to 25 cm and/or between 25 to 30 cm above the base 1110c of the “u” and/or the stabilizer 904a. Optionally, the stabilizer 904a is positioned below and/or equal to the base 1110c of the “u”. In some embodiments a padding is supplied at the base 1110c of the “u” and/or along areas that may contact the object being carried and/or the car (for example along the prongs 1110a, 1110b of the “u”). Optionally the top of one or both prongs 1110a, 1110b is configured to extend above the roof level of the car when the bracket 910a is mounted on a car door 922a. For example, the height of the prongs 1110a, 1110b may be long enough to hold a surfboard steady but short enough so that it is easy for an adult standing on the ground beside the car to lift up a surfboard above the prongs 1110a, 1110b and/or slide the surfboard down into the channel 1118 space between the prongs 1110a, 1110b. For example, the prongs 1110a, 1110b may project 0 to 5 cm above the roof of the car and/or 5 to 15 cm and/or 15 to 30 cm and/or 30 to 45 cm and/or 45 to 75 cm and/or more than 75 cm. Optionally the top of the prongs 1110a, 1110b may be the same height. Alternatively or additionally, the car side prong 1110b (e.g., on the side of the bracket 910a including the support 902 and/or the stabilizer 904a) may be project higher than the outer prong 1110a (for example the top of the outer prong 1110a may be between 0 to 5 cm higher and/or between 5 to 10 cm and/or between 10 to 30 cm and/or between 30 to 60 cm and/or between 60 to 100 cm higher than the top of the inner, car-side prong 1110b). Optionally a length of a prong 1110a, 1110b may be between 5 to 15 cm and/or between 15 to 30 cm and/or between 30 to 60 cm and/or between 60 to 120 cm and/or between 120 to 200 cm. The prongs 1110a, 1110b are optionally parallel. Optionally, the prongs 1110a, 1110b are straight. Alternatively or additionally, the prongs 1110a, 1110b may be curved and/or angled. Optionally the prongs 1110a, 1110b have a circular cross section. Alternatively or additionally, the prongs may be flat 1110a, 1110b and/or have a different cross section. Optionally there are two prongs 1110a, 1110b (e.g., forming a u-shape). Alternatively or additionally, there may be more prongs (e.g., more than one prong on each side of the bracket). Optionally the base 1110c of the u-shaped bracket 910a is rounded. Alternatively or additionally the base of the u-shaped bracket may be flat (e.g., the bracket may be rectangular) and/or angled (e.g., the bracket may be triangular e.g., v-shaped).

FIG. 12 is a frontal view image of a surfboard held on a car using a carrier in accordance with some embodiments of the current invention. In some embodiments, a bracket 910a is configured to lean inward, over the roof of a car, when the bracket is suspended from a car door and/or stabilized. For example, the bottom 1110c of the bracket 910a and/or surfboard 916 may sit beside the car door 922a and/or the top of the bracket (e.g., inner prong 1110b and/or outer prong 1110a) and/or the top of the surfboard 916 may lean over the roof 908 of the car. Alternatively or additionally, the top of the bracket 910a (e.g., inner prong 1110b and/or outer prong 1110a) and/or the top of the surfboard 916 may protrude upward above the side of the car and/or sit beside the car. Optionally the bracket 910a can hold one and/or two surfboards 916. For example, the channel 918 space in the u-shape of the bracket (between the prongs 1110a, 1110b) may be between 2 to 10 cm and/or between 10 to 20 cm and/or between 20 to 30 cm and/or between 30 to 40 cm and/or between 40 to 50 cm. Alternatively or additionally the prongs 1110a, 1110b may open upwards (e.g., be angled away from each other (for example at and angle of between 0 to 5 degrees and/or between 5 to 15 degrees and/or between 15 to 45 degrees)).

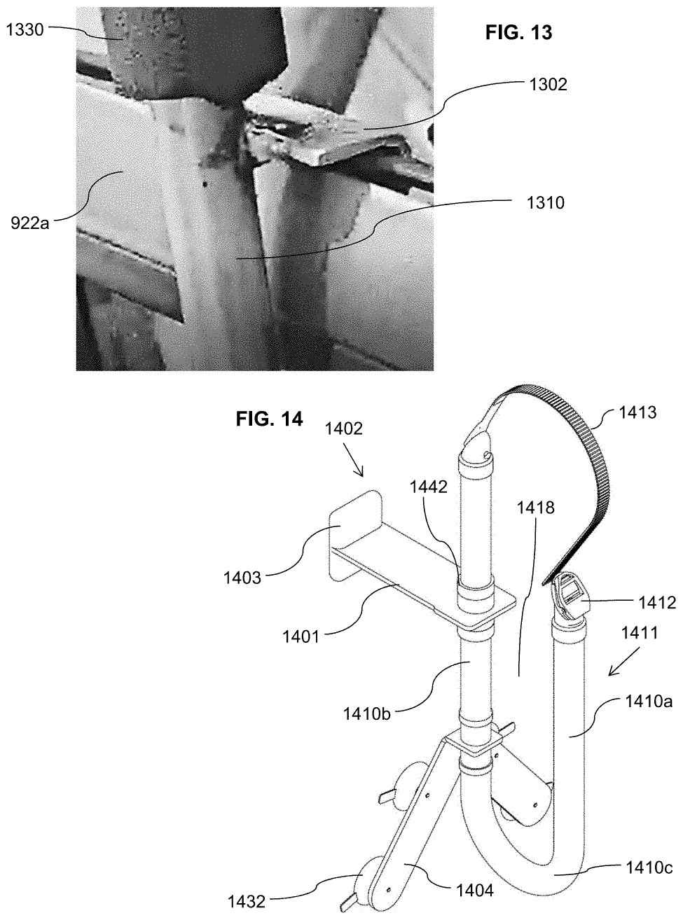

FIG. 13 is an image of hook 1302 hanging a mount on a car door 922a in accordance with some embodiments of the current invention. For example, stainless steel hook 1302 may be attached to an inner prong 1310 and/or support the bracket on a top of a door 922a frame. Optionally, when the door is closed, the hook 1302 is locked into place on top of the door 922a. Padding 1330 is optionally placed over parts of the bracket, for example, in order to prevent scratching an object supported by the bracket.

FIG. 14 is a perspective view of a carrier in accordance with some embodiments of the current invention. In some embodiments, a support 1402 supports a bracket 1411 on a car. For example, support 1402 may include a thin tongue 1401 that passes through the space between a top of a door and/or a nub 1403 that sits inside the car and prevents the tongue from being pulled out of the car door while the door is closed. In some embodiments, the tongue 1401 may be flexible and/or rotatable for example to facilitate mounting the bracket on different supports and/or on doors of different geometries (for example on a side passenger door and/or and on a rear hatch. For example, the brace may include a sleeve 1442 that fits over a prong 1410b of a bracket 1411. Optionally, the support 1402 may be rotated with respect to and/or removed from the bracket 1411, for example for easy storage.

In some embodiments, a bracket 1411 is attached to a stabilizer 1404. For example, stabilizer 1404 includes at least two contact points on the car. For example, the stabilizer 1404 keeps the bracket from twisting in any direction. For example, the stabilizer may include a V shaped frame and/or fasteners 1432 to attach to the car. Optionally, fasteners 1432 may include suction cups and/or magnets etc. For example, the stabilizer 1404 and/or support 1402 may be configured to hold the bracket 1411 perpendicular to the side of the car e.g., a line across the channel 1418 (e.g., from the center of the inner prong(s) 1410b to the center of the outer prong(s) 1410a) may be perpendicular to the car door and/or side fender when the bracket 1411 is mounted on a car. Optionally, the stabilizer 1404 and/or its legs may rotate and/or fold, for example for easy storage. For example, the stabilizer may extend between 1 to 5 cm on one or both sides of the prong 1410b and/or between 5 to 10 cm and/or between 15 to 25 cm. The distance between the juncture between support 1402 and prong 1410b and the bottom of stabilizer 1404 may range between 1 to 5 cm and/or between 5 to 10 cm and/or between 15 to 25 cm and/or 25 to 50 cm and/or between 50 to 100 cm and/or between 100 to 150 cm and/or between 150 to 250 cm. Optionally, the stabilizer 1404 may extend below the bottom 1410c of the bracket 1411. Optionally the support 1402 and/or the stabilizer 1404 are rigidly mounted to the inner prong. Optionally the support 1402 and/or the stabilizer 1404 may be flexibly mounted to the bracket. The distance between the support 1402 and the top of the inner prong 1410b may range between 1 to 5 cm and/or between 5 to 10 cm and/or between 15 to 25 cm and/or 25 to 50 cm and/or between 50 to 100 cm and/or between 100 to 150 cm and/or between 150 to 250 cm.

In some embodiments, a carrier includes a restraint. For example, the restraint may include a strap 1413 and/or a buckle 1412 that may be tightened to hold a surfboard in a bracket. For example, the strap 1413 and/or buckle may attach across the top of prongs 1410a and 1410b, for example to hold a surfboard inside gap 1418. Optionally the restraint has a quick release. For example, the strap 1413 may be mounted on the inner prong 1410b (e.g., near the top thereof). Optionally, the buckle 1412 and/or the quick release are mounted on the outer prong 1410a (for example near a top thereof). Placing buckle 1412 on the outer prong 1410a may allow easy access to a user standing beside the car. Optionally, the position of the strap 1413 may be fixed at various points along the length of inner prong 1410b for example there may be a ring that can be positioned along inner prong 1410b to hold the strap to a point on prong 1410b along its length. Optionally, the position of the buckle 1412 may be fixed along the length of inner prong 1410a hold the strap 1421 to a point on prong 1410a along its length. For example, this may be used to adjust the bracket to hold objects of smaller width (e.g., the strap 1413 can be moved down the prong 1410a, 1410b to grasp an object that has a width less than outer prong 1410a).

In some embodiments, a bag and/or box may be designed to hold one or more smaller objects on the bracket. For example, the bag or box may be long and thin to be held may the brackets. Optionally the bag or box may include drainage holes (e.g., to allow water to drain from example, from a set surfboard and/or a snow boards and/or poles that are caked with melting snow). Optionally, the box and/or bag may include multiple holding points (e.g., rings, loops) through which a strap 1413 may be threaded to hold the bag/box more surely.

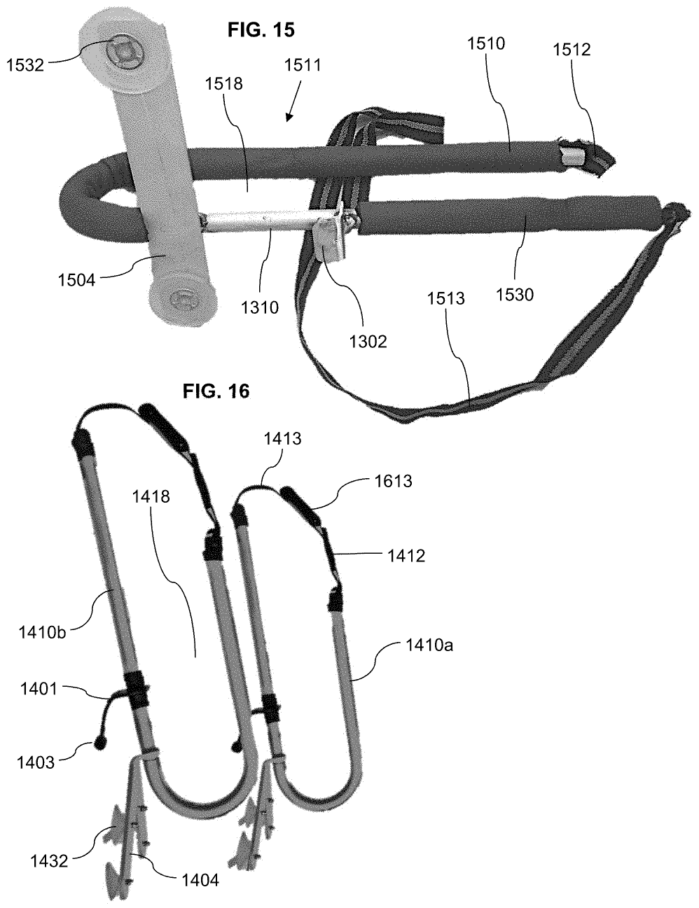

FIG. 15 is an image of a bracket in accordance with some embodiments of the current invention. In some embodiments, a stabilizer 1504 and/or a hook 1302 may be mounted to an inner prong 1310 of a bracket 1511, e.g., the stabilizer 1504 and/or hook 1302 may be configured to hold the bracket 1511 perpendicular to the side of the car e.g., a line across the channel 1518 (e.g., from the center of the inner prong 1310 to the center of the outer prong(s) 1510) may be perpendicular to the car door and/or side fender when the bracket is mounted on a car. For example, the stabilizer 1504 may extend between 1 to 5 cm on one or both sides of the inner prong 1310 of the bracket 1511 and/or between 5 to 10 cm and/or between 15 to 25 cm. The distance between the hook 1302 and the junction between stabilizer 1504 to prong 1310 may range between 1 to 5 cm and/or between 5 to 10 cm and/or between 15 to 25 cm and/or 25 to 50 cm and/or between 50 to 100 cm and/or between 100 to 150 cm and/or between 150 to 250 cm. For example, stabilizer 1504 may be attached to prong 1310 below hook 1302. Optionally, the hook 1302 and/or the stabilizer 1404 are rigidly mounted to the inner prong 1310. Optionally the hook 1302 and/or the stabilizer 1502 may be flexibly mounted to the bracket 1511. The distance between the hook 1302 and the top of the inner prong 1310 may range between 1 to 5 cm and/or between 5 to 10 cm and/or between 15 to 25 cm and/or 25 to 50 cm and/or between 50 to 100 cm and/or between 100 to 150 cm and/or between 150 to 250 cm. A stabilizer 1504 optionally includes at least two contact points on the car. For example, contact points could include fastener 1532 on either side of the stabilizer 1504 and/or prong 1510b. For example, the stabilizer 1504 keeps the bracket 1511 from twisting in any direction. Padding 1530 is optionally placed over parts of the bracket, for example, in order to prevent scratching an object supported by the bracket.

In some embodiments, bracket 1511 may include a restraint. For example, a restraint may include a strap 1513 that may attach to a buckle 1512 across the prongs 1310 and 1510 of the bracket 1511, for example to hold a surfboard in a gap 1518 of the bracket 1511.

FIG. 16 is an image of a brackets positioned for holding a surfboard in accordance with some embodiments of the current invention. In some embodiments a strap 1413 may have an adjuster 1613 for adjusting the length of the strap 1413 and/or tightening an object into the gap 1418. In FIG. 16 it is illustrated that an exemplary tongue may be bent downward for example to fit a door of a car.

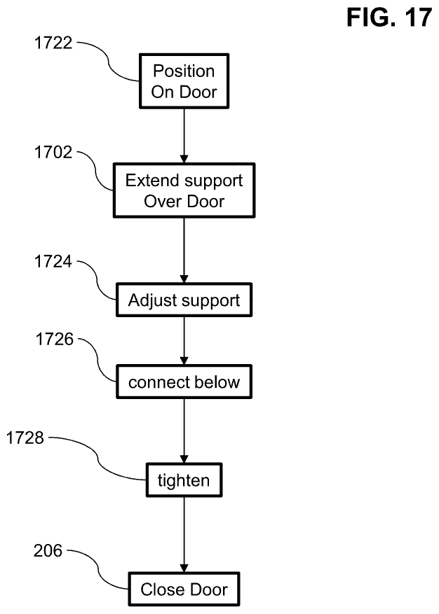

FIG. 17 is a flowchart illustration of a method of attaching a rack to a vehicle in accordance with an embodiment of the current invention. In some embodiments, the rack is supported by a brace. Optionally, the brace is positioned 1722 on a door of the vehicle. For example, the brace may be positioned 1722 outside and open door with a support extending 1702 over the frame of the door. Optionally, the brace will be steadied, for example by a temporary connection to the door (for example a suction cup connecting the assembly to the door and/or window). In some embodiments, the support may be adjusted 1724. For example, the support may be shorted, for example, a stopper may be tightened and/or fit precisely against the inner surface of the door frame (e.g., within 1 cm and/or within 3 cm and/or within 5 cm of the inner surface). For example, a stopper may be added to the support near the inner surface of the door. Alternatively or additionally, the support may be shortened (for example, by pulling it through a ratchet and/or using a strap) and/or bent. In some embodiments, a fastener may be connected 1726 to a lower portion of the vehicle by a counter force module. For example, a hook may be attached to the bottom of the door and/or the vehicle. Optionally, the counter force module is tightened 1728. For example, a strap may be tightened 1728 pulling upward on the lower fastener and/or downward on the support. For example, the fastener may be hooked onto the bottom of the door and/or may be pulled up against the bottom of the door. The door is optionally closed 206. For example, closing the door may clamp the support and/or the hook between the door (e.g., a doorframe thereof) and the vehicle (e.g., a frame thereof). Optionally, the support is immobilized to movement in at least one direction between the door and the vehicle. For example, when the assembly is pulled away from the car, a stopper may prevent the support from being pulled out from the car more than 0.5 cm, 1 cm, 2 cm and/or 5 cm).

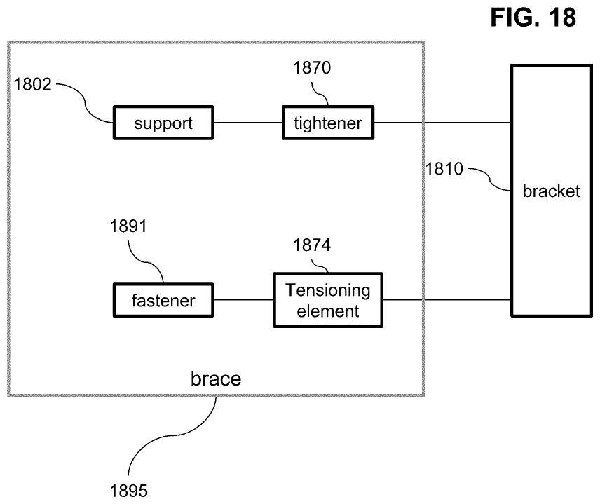

FIG. 18 is a block diagram of a bracket in accordance with an embodiment of the current invention. In some embodiments, a bracket 1810 is held to a vehicle by a brace 1895. For example, the brace 1895 may include a support 1802 that is clamped between a door and a frame of the vehicle. For example, the support 1802 includes a thin tongue that fits between the door and the frame and/or a tightener 1870 that tightens the door. For example, the support 1802 may include a nub that fits inside the door and/or a mechanism for shortening the tongue such that the nub is brought up against an inner surface of the door. For example, a ratchet may shorten the tongue and/or the tongue may fold. Alternatively or additionally, a movable stopper may be positioned (e.g., movably along the tongue) against an inner surface of the door. For example, the support 1802 may support the weight of the bracket 1810 and/or the weight of objects being held by the bracket 1810 against gravity and/or winds.

In some embodiments, the brace 1895 includes a counter force module. For example, the counter force module may include lower fastener 1891. For example, the lower fastener 1891 may include a tensioning element 1874 (e.g., a strap and/or a ratchet) to tension the brace 1895 against the support 1802 thereby holding the brace 1895 immobile and/or stable. For example, the tensioning element 1874 may include fastener 1891 (e.g., a hook and/or a magnet) that attaches to a lower part of the vehicle (e.g., the bottom of the door and/or the bottom of the chassis of the car) and/or a connector that can be tightened (e.g., a strap, a ratchet, a clamp, a spider and/or an elastic element (e.g., a bungee)).

In some embodiments, a brace 1890 may include a stabilizer. For example, the stabilizer may attach and/or rest on a surface of the door (e.g., an outer surface thereof for example an outer surface of a window, a door panel and/or a fender of the door). For example, the stabilizer may hold the bracket in place while attaching the support 1802 and/or the counter force module and/or while the door is open (such that the support is not being held by the door).

In some embodiments, a bracket 1810 may be entirely attached to a door in such a way that the door can be opened and/or the bracket 1810 moves with the door without needing to disconnect the bracket 1810. For example, the support 1802 of the bracket 1810 may be attached to the top of the door and/or clamped between the door and the frame of the car. The counter force module may be attached to the bottom of the door. A stabilizer may rest upon and/or be attached (e.g., via a magnet and/or a suction cup) to the surface of the door.

In some embodiments, there may be multiple brackets 1810. Each bracket 1810 may be connected to a different door and/or place on the vehicle. Each bracket 1810 may be independent and/or more independently. For example, a first bracket 1810 on a front door may move with the front door. For example, a second bracket 1810 on a rear door may move with the rear door. Sometimes. the front and/or rear doors may be opening and closed without removing the brackets 1810. Optionally, two or more brackets 1810 may be used to carry one object (e.g., a long object) e.g., a surfboard. In some embodiments, the object may connect the brackets 1810 and/or prevent them from moving independently and/or preventing a door from opening until the object is taken off of the bracket 1810.

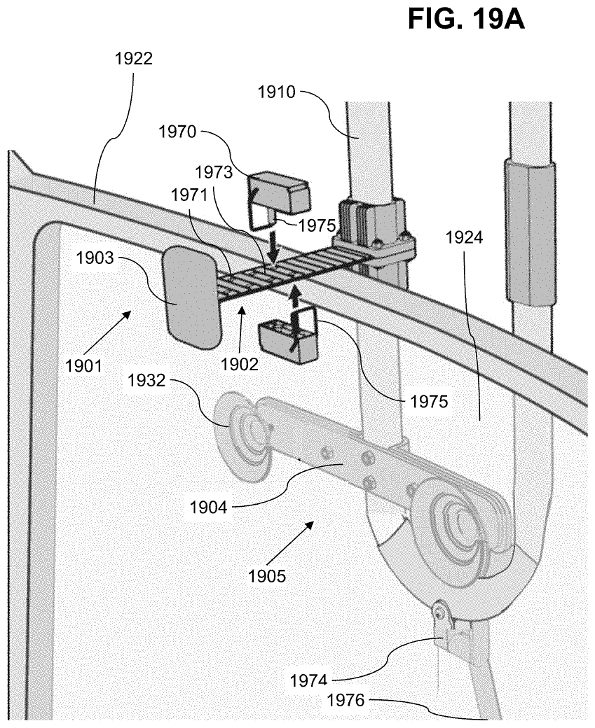

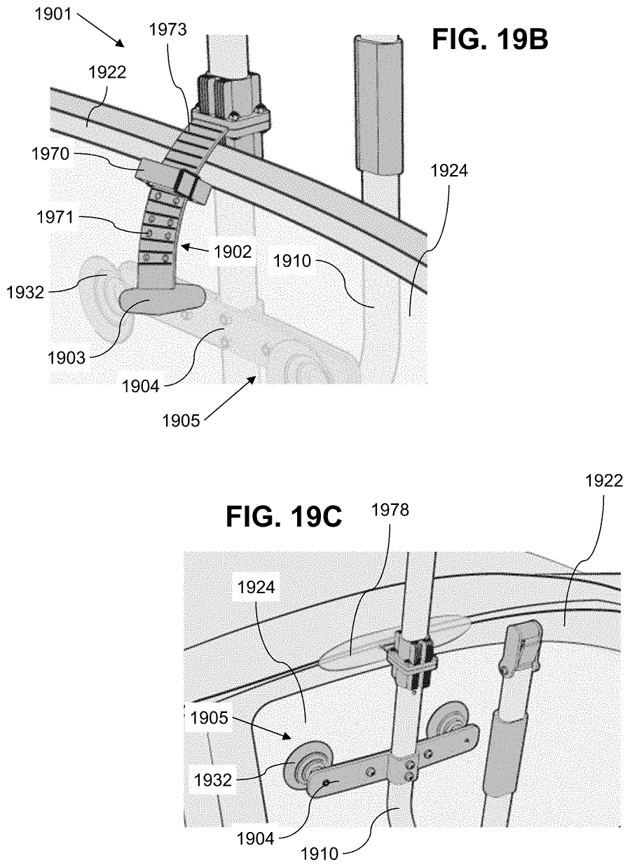

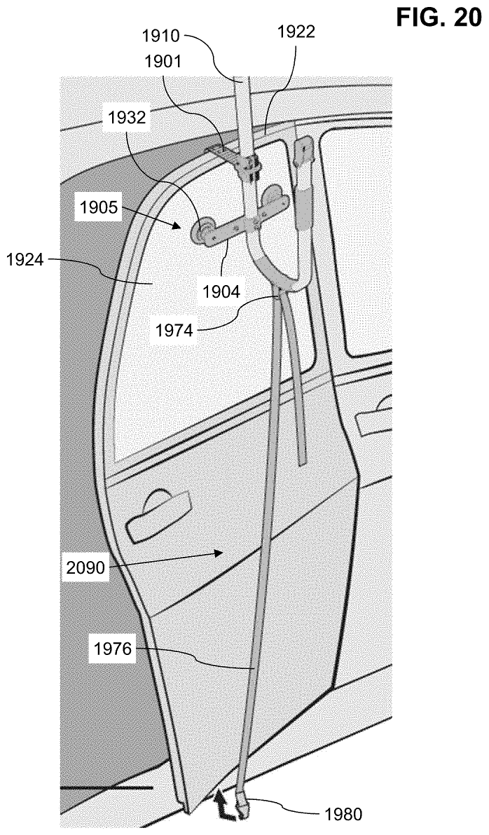

FIG. 19A is a perspective view from the inner side of the door of attaching an adjustable brace attaching a bracket 1910 into a door in accordance with an embodiment of the current invention. For example, the brace may include a support 1901 and/or a stabilizer 1905 and/or a counter force module. In some embodiments, a support 1901 includes thin tongue 1902 with location features along its length for locking to an object. For example, the location features of the tongue 1902 may include ribs 1973 and/or holes 1971. For example, the ribs 1973 inhibit the tongue 1902 from sliding longitudinally with respect to an object when clamped to the object (e.g., when clamped between a door 1922 and a frame of a car body). Alternatively or additionally, a stopper 1970 may lock to the tongue 1902. For example, the stopper 1970 may define a location past which the tongue 1902 is inhibited from sliding (Alternatively or additionally, a nub 1903 may serve this function). Optionally, the stopper 1970 locks to the to a location feature of the tongue 1902 such as holes 1971 and/or ribs 1973. For example, the stopper may include two parts clamped onto the tongue 1902 with a fastener 1975. For example, the tongue may be adjusted to a length between 3 to 15 cm. Optionally, the position of support 1902 may be adjustable (e.g., it may be slide to different heights (e.g., positions) along the bracket 1910. For example, for a surfboard that is wide in front and thin in the back, the front bracket may be positioned lower than the back bracket e.g, keeping the top of the surfboard more or less even.

In some embodiments, a stabilizer 1905 supports the bracket 1910 on a surface of the vehicle (e.g., a door panel and/or a window thereof). For example, stabilizer 1905 include a fastener (e.g., suction cups 1932 and/or a hook and/or a magnet) for attaching to the vehicle and/or a scaffold 1904 (e.g., a cross bar) attaching the fastener to the bracket 1910 to a surface. For example, the stabilizer may be attached a to a door panel and/or a window 1924. Optionally, the stabilizer may be strong enough to hold the bracket 1910 to the vehicle and/or in place while the car is parked and/or when there is not weight on the bracket 1910. For example, this holds the bracket 1910 in place while support 1901 and/or a counter force module are being attached. Additionally or alternatively, the stabilizer 1905 may distance the bracket 1910 from the vehicle and/or the stabilizer may be compressed between the bracket 1910 and the vehicle when the bracket 1910 is tightened onto the vehicle between the support 1901 and the counter force module. Optionally, the support (e.g., scaffold 1904) may be adjustable (e.g., its width may telescope to different widths and/or it may be slide to different heights (e.g., positions) along the bracket 1910.

In some embodiments, a counter force module tensioning element for example a strap 1976 and/or a ratchet 1974. Optionally, the tensioning element and/or the strap is mounted on a pivot allowing it to be directed with the tensions. For example, as illustrated in FIG. 20.

FIG. 19B is a perspective view from an inner side of the door of attaching an adjustable brace attaching a bracket 1910 into a door with a bent tongue 1902 in accordance with an embodiment of the current invention. In some embodiment, the tongue 1902 clamped between the door 1922 and the vehicle frame may be malleable and/or may be bent (e.g., to save space in the car and/or to better support the bracket 1910). Optionally, stopper 1970 and nub 1903 may rest against and/or lock to (e.g., via an ridge and/or an interference element and/or friction) to a lower surface of the frame of the door 1922 and/or window. Optionally, interference and/or friction between the stopper 1970 and/or nub 1903 the with the frame of the door 1922 and/or window may inhibit the tongue 1902 from sliding outward.

FIG. 19C is a perspective view from an outer side of the door of attaching an adjustable brace attaching a bracket 1910 into a door with an external shield 1978 in accordance with an embodiment of the current invention. In some embodiments, a shield 1978 may be positioned on the tongue 1902 where it passes between the door 1922 and the frame of the car against an outer surface of the car. For example, the shield 1978 may prevent water (e.g., due to rain) from infiltrating into the car around the tongue 1902. In some embodiments, the shield 1978 may include a gasket and/or an adhesive to further inhibit water from entering the vehicle. Alternatively or additionally, the shield 1978 may be attached to the tongue and/or may inhibit movement of the tongue with respect to the car. For example, the adhesive may be a reusable adhesive that can be used, removed and used again, for example cold silicon sealant.

FIG. 20 is an external perspective view of attaching a bracket to a car in accordance with an embodiment of the current invention. In some embodiments, a stabilizer 1905 is positioned and/or attached to a surface of the door (e.g., attached to window 1924 via suction cups 1932). Optionally, the stabilizer 1905 holds the bracket 1910 steady while support 1901 is placed over the top of the door 1922 and/or while a counter force module (e.g., including a fastener (e.g., hook 1980) and/or a connector (e.g., strap 1976) and/or tensioning element (e.g., ratchet 1974)) is attached to the bottom of the door 1922. Optionally the bracket 1910 will be fully attached to the door 1922 by closing the door 1922 with the support clamped between the door 1922 and the frame of the car and/or by tightening the counter force module (e.g., tightening strap 1976 by pulling it through ratchet 1974).

In some embodiments, stabilizer 1905 is attached to an upper portion (e.g., an upper ½ and/or an upper ¼ and/or an upper ⅛ of a car window 1924 near the upper door frame and/or towards the middle of the window (and not on either ⅛ side of the window) and/or not in a lower portion of the window 1924. Optionally, the support 1901 is attached between the door 1922 and the frame of the car in a place with the top of the door is horizontal and/or not in a location where the frame of the door 1922 is included downwards at an angle of greater than 2 degrees and/or between 2 to 10 degrees and/or between 10 to 30 degrees from the horizontal.

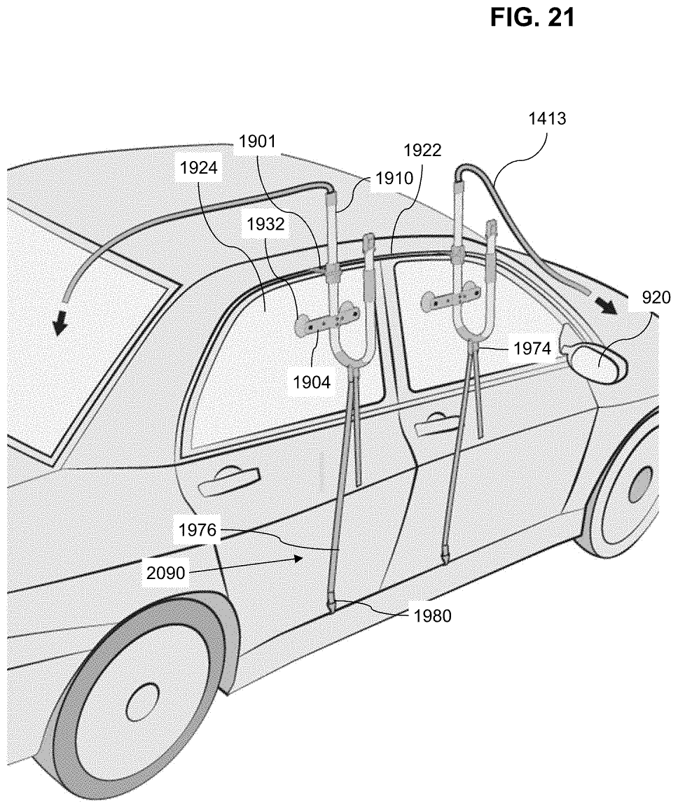

FIG. 21 illustrates a set of brackets 1910 attached to a car for carrying an object in accordance with an embodiment of the current invention. In some embodiments, a pair of brackets 1910 are attached to a car (e.g., as described herein above). Optionally, one bracket 1910 is attached to the front passenger door and/or a second bracket 1910 is attached to a rear door on the same side of the car. Optionally, a long object (e.g., a surfboard, a ladder, a plank, skis, a bicycle) is supported by the two brackets 1910. In some embodiments while they are not carrying a shared load, each bracket 1910 is fully supported on one door which can be opened and closed without detaching the stabilizer 1905 and/or the counter force module 2090. Optionally, with the support 1901 and the counter force module 2090 attached and/or tightened, stabilizer 1905 holds the bracket 1910 away from the surface of the car and/or stabilizer 1905 is compressed between the bracket 1910 and the car surface (e.g., window 1924).

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

It is expected that during the life of a patent maturing from this application many relevant technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A carrier for support an object alongside a car comprising:
a plurality of brackets, each bracket including
each of said plurality of brackets including a respective brace for support the bracket on the car;
an open topped profile configured to support the object from at least two sides.

2. The carrier of claim 1, wherein each said respective brace is configured for supporting the bracket on a door of the car.

3. The carrier of claim 1, wherein each said respective brace includes a support configured to be held between a closed door and a roof of the car.

4. The carrier of claim 3, wherein a length of said support is adjustable.

5. The carrier of claim 4, wherein said support includes a movable stopper which is moved along a length of said support thereby adjusting the length of the support.

6. The carrier of claim 1, wherein a long dimension of each bracket of said plurality of brackets is less than 3/2 meters.

7. The carrier of claim 1, further comprising:
a stabilizer configured to attach to a surface of a car.

8. The carrier of claim 1, wherein the carrier is configured to hold a surfboard on a moving car within the profile defined between the side mirrors of the car.

9. The carrier of claim 8, wherein the carrier is configured to carry a portion of the surfboard below a roof line of the car.

10. The carrier of claim 1, wherein each said bracket includes at least two upward directed prongs with a gap between the prongs for holding the object.

11. The carrier of claim 10, wherein each of said plurality of brackets is configured such that when the carrier is supported on a car, the gap between the prongs is directed along a width of the car.

12. A method of carrying an object comprising:
reversibly mounting a plurality of brackets on a one side of a car each bracket having a gap opening on an upper portion thereof;
passing the object downward through the opening into the gap of each of the plurality of brackets;
supporting part of a weight of the object on each of the plurality of the brackets with a length of the object along the length of the car.

13. The method of claim 12, wherein for each of said brackets, said mounting includes supporting a weight of the bracket on a door of the car.

14. The method of claim 13, wherein each said bracket includes a support and wherein said supporting includes positioning said support above a frame of said door and closing said support between said door and a frame of said car.

15. The method of claim 14, further comprising adjusting the length of the support to fit tightly to the door.

16. The method of claim 15, wherein said adjusting includes attaching a movable stopper to the support.

17. The method of claim 14 further comprising: attaching a fastener to a bottom of said door and applying a contra downward force on said support from said fastener.

18. The method of claim 14, wherein each of said plurality of brackets includes a stabilizer and said mounting further includes stabilizing the bracket by connecting a stabilizer to the car.

19. The method of claim 18, wherein said stabilizing includes attaching said stabilizer to a surface of the car.

20. The method of claim 12, wherein said supporting includes supporting a portion of the object under a roof line of the car and a portion of the object above the roof line of the car.
